(19) United States
(12) Patent Application Publication
(10) Pub. No.: US 2009/0047057 A1
(43) Pub. Date: Feb. 19, 2009

(54) EXTENDABLE ELASTIC DOCUMENT FASTENER

(76) Inventor: Juan Roberto Tirado Alanis, Colonial Agricola Oriental (MX)

Correspondence Address: MITCHELL P. BROOK;LUCE, FORWARD, HAMILTON & SCRIPPS LLP, 11988 EL CAMINO REAL, SUITE 200, SAN DIEGO, CA, 92130, US

(21) Appl. No.: 11/659,581

(22) PCT Filed: Aug. 8, 2005
(86) PCT No.: PCT/MX2005/000066

§ 371 Date: Sep. 22, 2008

(30) Foreign Application Priority Data
Aug. 9, 2004 (MX) PA/A/2004/007724

(51) Int. Cl. B42F 3/00

(52) U.S. Cl. 402/62

(57) ABSTRACT

This invention is an extendable elastic document fastener for fastening from one single document to any amount or thickness required, because its elastic string can be obtained in every length required and its ends can be given a pointed shape to pass them more easily through the documents. Fastening is carried out in a practical and quick manner and without damaging the documents, since one can add or extract documents practically at any time. This fastener is very resistant and adaptable to all types of climates. It will not stain the documents because it is not made of metal. It eliminates the need for stitching and for traditional fasteners, which, as I have learned from experience, damages the documents. It saves time and costs and reduces damages to the documents; it is adequate for conserving any type of archives. It offers the advantage of allowing one to view information printed on the middle of the documents close to the fastener that is not easily accessible, by pulling at the center towards the ends without the risk of tearing the documents, since it is elastic and does not damage the punch holes on the document. To make copies, one need only loosen the string, separate the top plate from the document to be copied, place the string in the fastening tracks, and then open the documents completely as desired.

### INVENTED OBJECT

This invention is an extendable elastic document fastener for fastening from one single document to any amount or thickness of documents required, in a practical and quick manner and without damaging said documents. This fastener is very resistant, versatile for all types of documents and adequate for all climates.

### BACKGROUND

Nowadays, commercially available fasteners are very limited in terms of the amount and thickness of the documents to be fastened and the care of said documents. Metal staple fasteners cut through documents with constant use and begin to rust in humid climates, thus damaging the documents. This type of fastener is useless for fastening amounts of documents which thickness Is larger than the fastener's fastening length. For larger amounts of documents, there are ring-, u-shaped- or lever-fasteners attached to a binder or folder. This poses the disadvantage of taking up more space upon filing, since the metal fastener needs to be given space within the binder or folder, on the spine of the documents, and thus space is lost in the files. Metal fasteners begin to rust, staining the documents.

The only thing that exists nowadays to fasten more documents—and from the time the Spaniards arrived in Mexico and historic archives were first created—, is sewing with conventional string, and even then the stitches must be loose to avoid cutting up the documents with the string. Taking this into account, and the fact that there are no products in the market that are not made of metal and that are used to fasten documents to be kept for long periods, there is an additional disadvantage that loose sheets cannot be added or removed in a practical manner without having to take apart the stitches and sew them up again, which wastes time and may damage the documents, because the string sometimes breaks the holes through which it passes. Taking into consideration all of the above, no type of fastener allows one to see the information printed on the documents close to the fastener or stitches, unless they are left loose, thus diminishing the clasping properties and making the package of documents less compact, which in turn damages the punch holes. On the other hand, if one fastens the documents too tightly to be able to handle them better, one cannot have access to the information printed on the center close to the fastener or stitches.

If one were to try to access that information by introducing one's fingers forcibly in the center and pulling in the opposite direction from where the documents are fastened by the fastener, the documents would tear. The fastener described in this patent allows this to be done, since it is elastic and does not damage the punch holes or the documents. Furthermore, it can be seen that there is great need to eliminate unnecessary movements and thus save man-hours, costs and space, if there were to exist a better way of fastening the documents, avoiding their damage as well as contact with substances or matter that could stain or damage them.

With all these inconveniences in mind, I developed this fastener, which I wish to protect through this request, since it is a novel fastener that will invariably alter the way archivists work, making it easier for them to handle files, since it will fulfill certain basic needs of their work.

### DETAILED DESCRIPTION OF THE INVENTION

To provide a better idea of the advantages and novelties provided by this invention, I will give a detailed and illustrated description:

The fastener which hereby referred to is made up of two plates (1,2) that may be rectangular or any other shape that meets the need for fastening documents. Plate #1 is grooved longitudinally down the middle uniting the punch or drill holes (3 and 4) where the band or string (12) will be lodged; the groove will have the same diameter as the band. On plate #2 there are four grooves or tracks: two (10 and 11) are for fastening and run from the plate's narrower sides to its center changing direction at the center of the plate towards the drill or punch holes through which the string or band (12) will pass; the other two resting grooves or tracks which also run from the narrower sides parallel to the fastening tracks (10 and 11) up to the same level as the punch or drill holes (5 and 6), are located equidistantly between the punch hole and the fastener's side wall All of the above tracks or grooves are as deep as the thickness or gauge of the string or band (12).

These plates can be made of polypropylene plastic, which contains no acids or which can not be degraded with time, such as conventional fasteners made of metallic materials, which can stain or damage documents. These plates (1 and 2) can be made of this material or any other material that can be used to create the design presented here, which will be able to fit a round elastic band or string (12) made of low-density polypropylene or any other material that is extendable and can fasten documents in this manner. This band (12) will pass through the holes in the documents in a simple and easy-to-handle manner (FIG. 14) by entering into the holes on the top plate (2) becoming tense and passing through the fastening tracks (10, 11) and into the resting tracks (8, 9) (FIG. 17). This string (12) can be fastened in this manner or through other fastening methods that make the most of its characteristics.

This fastener can be used individually or together with other accessories such as covers, folders, boards or binders that can act as the binding of a book.

The lower plate (1) that has the band lodged in a groove or track (7) will leave the two ends of the band (12) free to be put through the holes of the documents, covers, folders, boards or binders (FIGS. 13 and 14). Once the documents have been passed through, we can place the receiving plate (2) by passing the band (12) through the holes of the plate and sliding and lowering the plate until it touches the documents or material to be worked with (FIGS. 14 and 15). Then, one holds the free ends making the necessary tension so that the band (12) stretches and grows thin and then one places said band (12) in the receiving grooves or tracks (10, 11), which are thinner than the thickness of the band or string (12), so that they will be caught or fastened in this manner (FIG. 16), allowing the material to recover its memory and thus regain its former shape and the same thickness it had when it was not tense in the grooves (10, 11). Leaving the ends of the band (12) free, one places them in the resting grooves (8, 9) (FIG. 17) so that the ends aren't left loose. If one wanted to add or extract a document, one need simply pull the band (12) by the ends and dislodge it from the grooves or tracks (8, 9, 10, 11) to easily remove the receiving plate (2) and this way one will have access to any part of the set of documents in a practical manner, saving time and without damaging the documents.

### BRIEF DESCRIPTION OF THE FIGURES

The figures described hereafter will provide a more comprehensive idea of the extendable elastic fastener:

FIG. 1 shows a plan view of the lower part of the bottom plate (1) where the string's (12) lodging track (7) is located. Generally, the midsection of the string or band is located here.

FIG. 2 shows a plan view of the upper part of the bottom plate (1) with two drill or punch holes (3, 4) through which the string (12) that will pass through the documents will go (FIG. 14) towards the top plate for fastening.

FIG. 3 shows a plan view of the lower part of the top plate (2) where we can see two drill or punch holes (5, 6) through which the string (12) will go from the bottom plate (1).

FIG. 4 shows a plan view of the top plate (2) of the fastener, where there are four grooves or tracks, two of which (10 and 11) will be used for fastening and which go from the plate's narrower ends to its center, with a deviation in its center towards the drill or punch holes through which the string or band (12) passes, as well as the other two resting grooves or tracks that also go from the narrower sides parallel to the fastening tracks (10 and 11) on the same level as the punch or drill holes (5 and 6), respectively, at the midsection equidistantly between the punch hole and the fastener's side wall. All of the above are as deep as the thickness or gauge of the string or band (12).

FIG. 5 shows a perspective view of the lower part of the bottom plate (1), where we can see the string's (12) lodging track (7) where said string will be hidden so as not to rest on the plate itself (1) and thus damage the documents. Generally, the midsection of the string's (12) length will go here, although it can be fastened. This fastener is designed in such a way that it can also be made with three or more strings.

FIG. 6 shows a perspective view of the upper part of the bottom plate (1) where we can see the two drill or punch holes (3, 4) through which will be inserted the string (12) that will pass through the documents.

FIG. 7 shows us a perspective view of the lower part of the top or fastening plate (2), where we can see the drill or punch holes (5, 6) through which the string or band (12) will pass on from the bottom plate (1) and part of the fastening and resting tracks (9, 11) now located on the lower part.

FIG. 8 shows a perspective view of the upper plate (2) where we can more clearly see the fastening tracks (10, 11) and the resting tracks (8, 9), including part of the drill or punch holes (5, 6) through which the string (12) will pass from the bottom plate (1).

FIG. 9 shows a perspective view of the assembled fastener without documents, to get a better idea of how it works. We can see that the fastening string (12) is cut, to give the idea that it is longer than it looks on the drawing. Its ends are pointed so that it can be inserted more readily into the holes in the documents. The string (12) fastens together the bottom (2) and top (1) plates. Please note that the documents will be fastened between these two plates (1, 2) by the string (12).

FIG. 10 shows a perspective view of the assembled fastener without documents, where we can see that the fastening string (12) has been lodged in the fastening track (10, 11), but we have yet to place the remaining portion of string with pointed ends (12) in the resting tracks (8, 9).

FIG. 11 shows a perspective view from the top of the fully assembled fastener, where we can see that the string (12) has been lodged and hidden in the fastening tracks (10, 11) as well as the resting tracks (8, 9).

FIG. 12 shows a perspective view from the bottom of the fully assembled fastener, where we can see that the string's (12) midsection is already lodged in the track (7) in order to be hidden. The string continues from here to assemble the fastener completely. Generally, the midsection of the length of string (12) will go here, although the design can be made the most of by drilling a hole in this plate's midsection so that a fixed band can go towards plate #2. This fastener is designed in such a way that it can also be made with three or more strings.

FIG. 13 shows a perspective view of plate #1, where we can see that the string or band (12) has been introduced in the drill holes (3, 4) to be sheltered in track #7.

FIG. 14 shows a perspective view of plates #1 and 2, where we can see the way in which the band passes from plate #1 through the documents towards plate #2 for fastening.

FIG. 15 shows a perspective view of the documents, where we can see that plate #1 has already been slid over band #12 to start fastening the documents.

FIG. 16 shows a perspective view of the documents with fastening plate #2, where we can see that string or band #12 has already been lodged in fastening tracks or grooves #10 and 11.

FIG. 17 shows a perspective view of the fully assembled fastener over plate #1, in which the loose ends of the band have been placed in resting tracks #8 and 9.

FIG. 18 shows how to hold the string and fastener in order to place the string in fastening groove #11.

FIG. 19 shows how to hold the string and fastener in order to place the string in fastening groove #10.

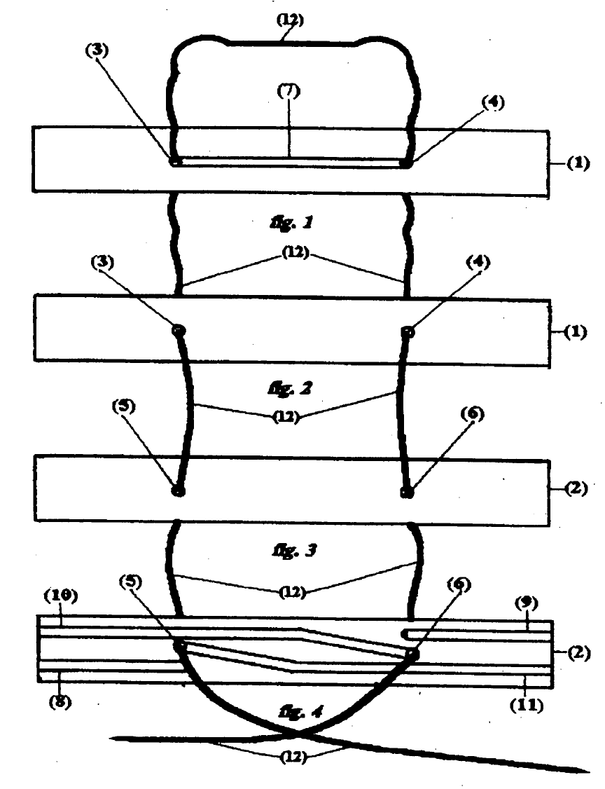

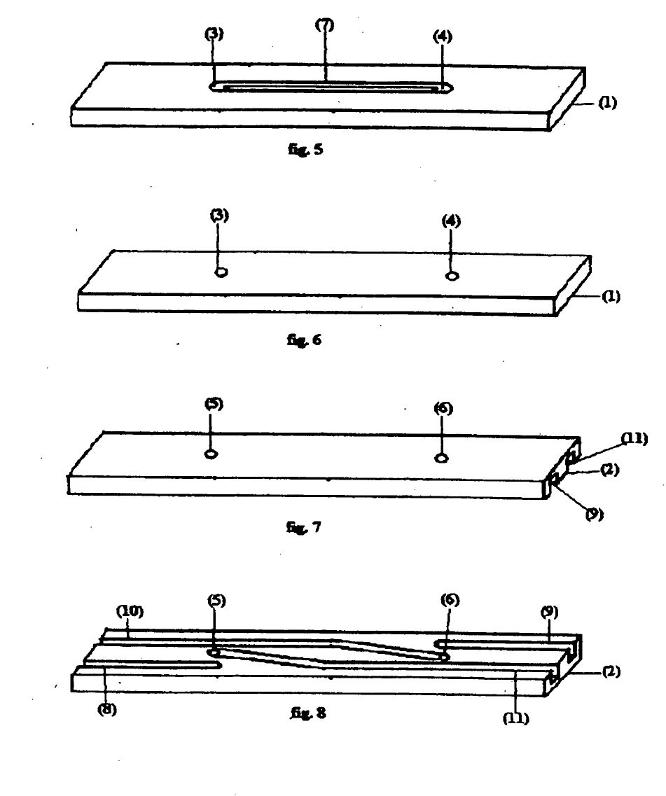

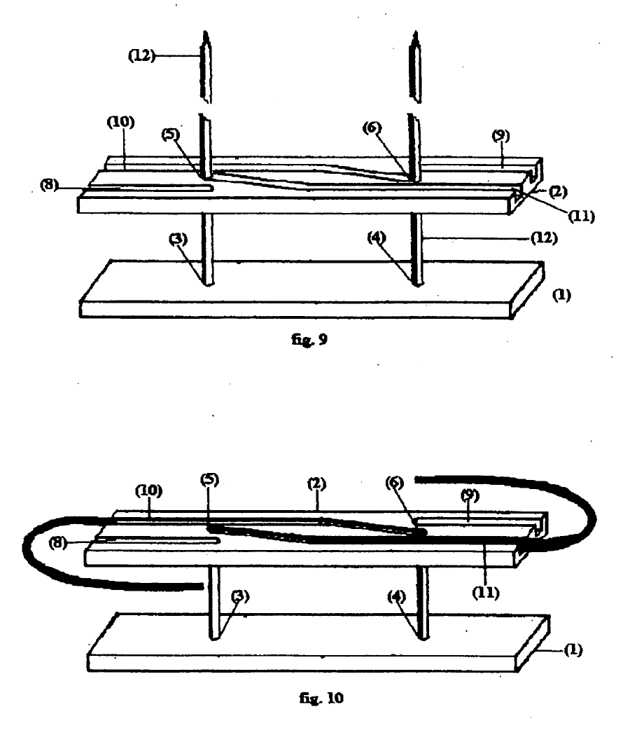

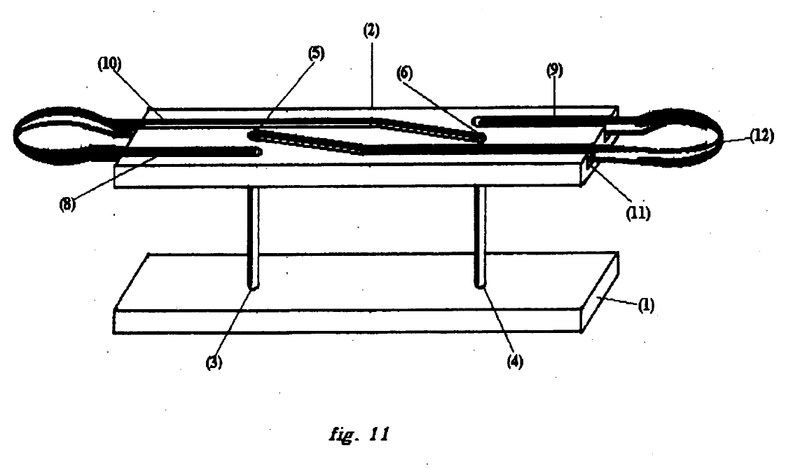

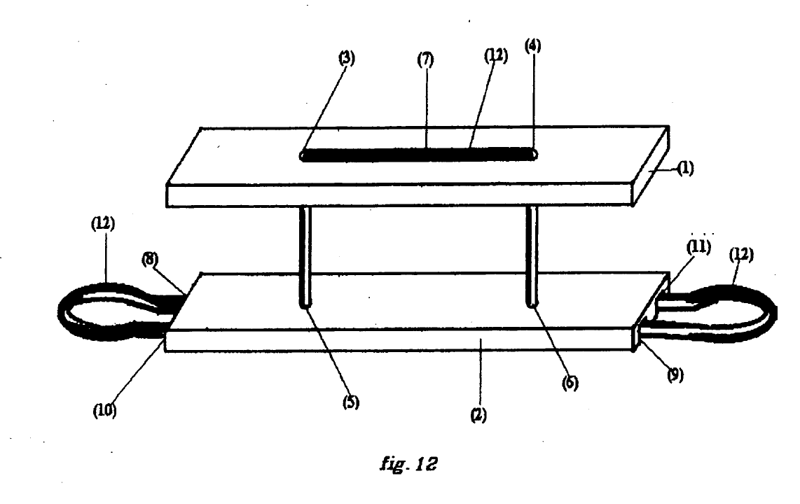

### DESCRIPTION OF THE PREFERRED USE FOR THE INVENTION

The preferred use for this invention is as extendable document fastener, which in combination with other accessories can be very versatile, for example by fastening boards or binders to give the appearance of a bound book.

The extendable fastening fastener will give us the advantage of assembling document files in a short time following this step-by-step procedure:

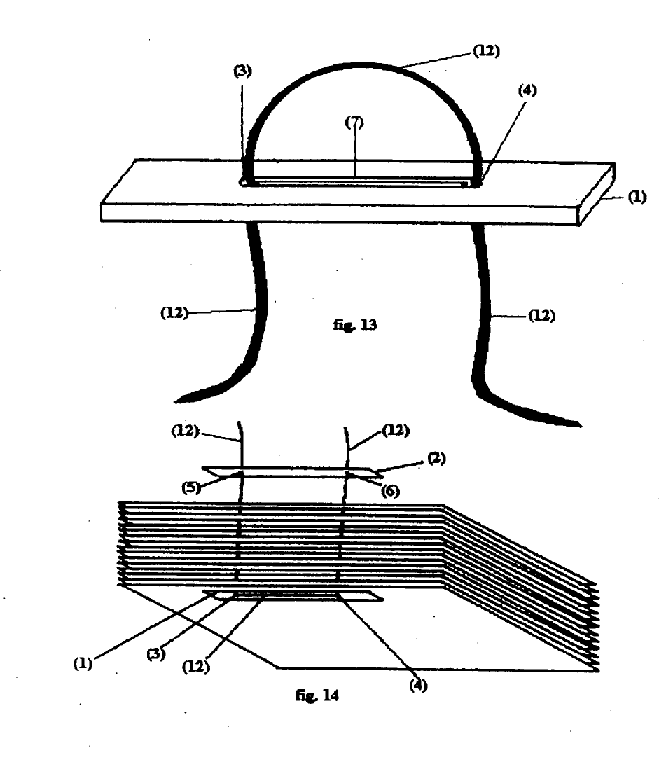

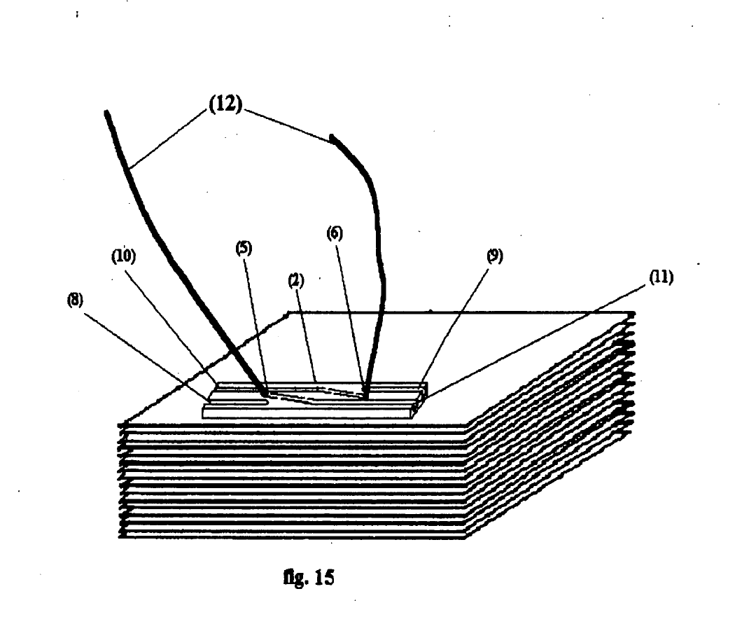

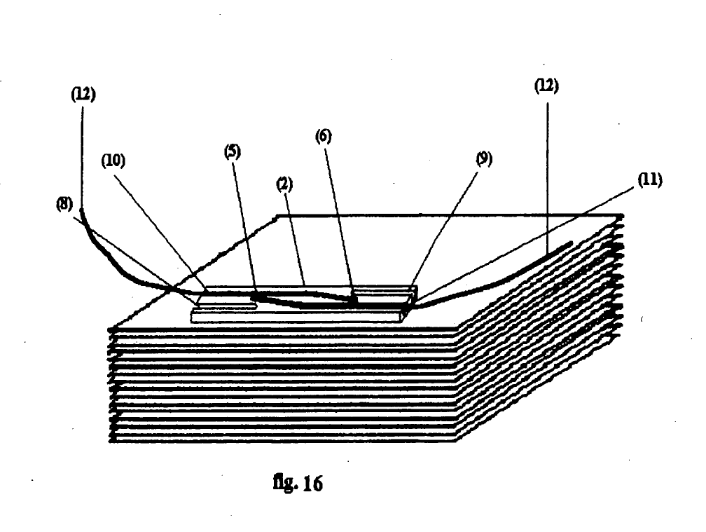

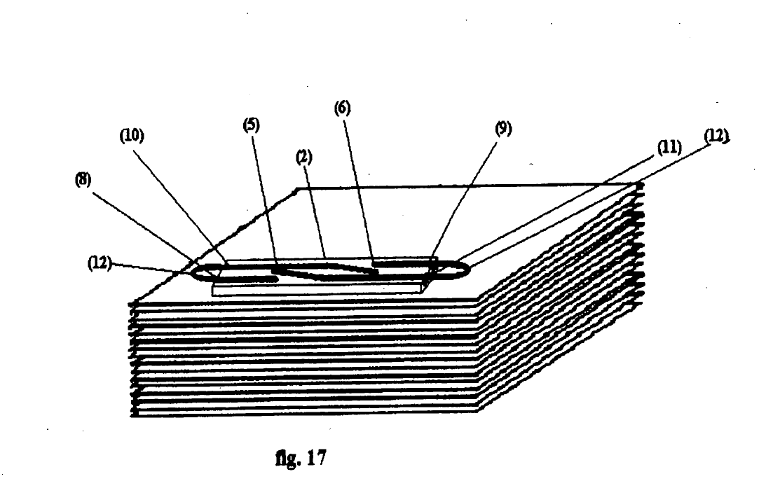

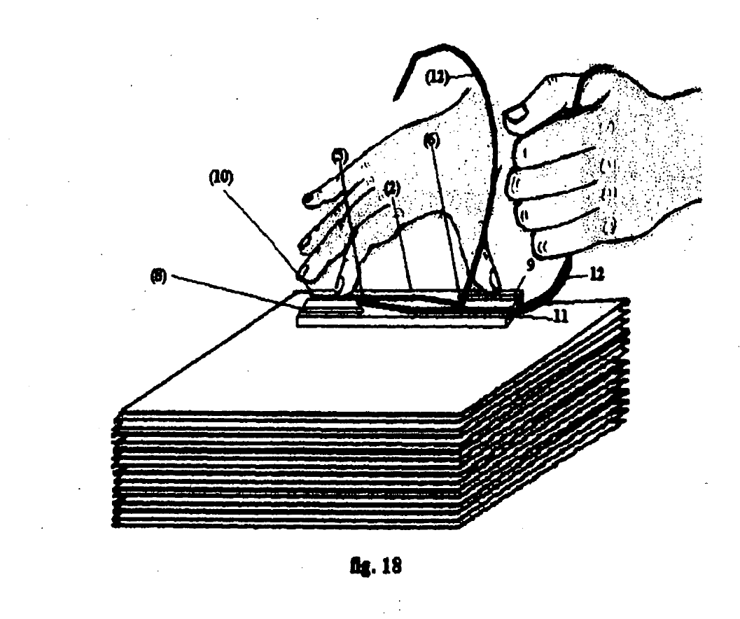

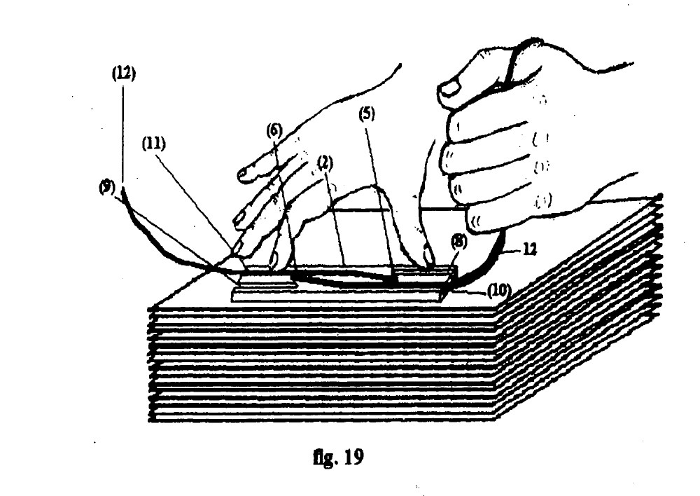

Fasten the midsection of the elastic string (12) in the bottom plate (1), leaving two ends of the band in the shape of points or loose ends (FIG. 13).
1. Pass the pointed ends of the string (12) through the holes previously punched through the documents with a conventional hole puncher (FIG. 14).
2. Pass the elastic string (12) through the top plate (2), sliding it until it touches the documents (FIG. 15).
3. While holding the plate (2) firmly and pressing it down towards the documents, pull the string (12), which will grow thinner because of the tension, place it in the fastening track (11), and let go. The string will try to regain its original shape or diameter, and will thus be trapped in the fastening groove (11), since said groove is narrower than the initial diameter of the string or band (FIG. 18).
4. Again, hold the top or fastening plate (2) as you pull the other end of the string (12), making it thinner with the tension; place the string in the fastening track (10) and let go. The string will try to regain its original shape or diameter, and will thus be trapped in the fastening groove (10) (FIG. 19).
5. Place the remaining ends of the string in the resting tracks (8, 9) (FIG. 17), and the document file will be assembled.

1. A fastener, comprising:
a first plate including a groove extending between first and second holes extending through the first plate;
a second plate including
a first fastening grooves including a first portion extending from a first side of the second plate to a second portion of the first fastening groove that is angled relative to the first portion and which extends from the first portion to a third hole extending through the second plate,
a second fastening groove including a third portion extending from a second side of the second plate to a fourth portion of the second fastening groove that is angled relative to the third portion and which extends from the third portion to a fourth hole extending through the second plate,
a first resting groove extending from the first side of the second plate to a location adjacent and spaced from the fourth hole, wherein the first resting groove is parallel to the first portion of the first fastening groove, and
a second resting groove extending from the second side of the second plate to a location adjacent and spaced from the third hole, wherein the second resting groove is parallel to the third portion of the second fastening groove; and
an elastic band having a rest thickness and a stretched thickness that is less than the rest thickness;
wherein the longitudinal groove, the first and second fastening grooves, and the first and second resting grooves have a depth that is at least equal to the stretched thickness of the elastic bands.

2. The fastener of claim 1, wherein at least a portion of the first fastening groove and at least a portion of the second fastening groove have a width that is less than the rest thickness of the elastic band.

3. The fastener of claim 1, wherein the second plate is rectangular and the first and second sides are the narrow sides of the rectangular second plate.

4. The fastener of claim 1, wherein the elastic band includes pointed ends.
